(19) United States
(12) Patent Application Publication
(10) Pub. No.: US 2026/0073553 A1
(43) Pub. Date: Mar. 12, 2026

(54) TAG SURVEY USING VISUAL MARKERS

(71) Applicant: QUALCOMM Incorporated, San Diego, CA (US)

(72) Inventors: Thomas ALLAN, St Neots (GB); Abhishek PRASAD, Barrington (GB); Tingting LIU, Cambridge (GB); Joe THOMAS, Cambridge (GB)

(21) Appl. No.: 18/883,724

(22) Filed: Sep. 12, 2024

(51) Int. Cl. G06T 7/70

(52) U.S. Cl. CPC G06T 7/70; G06T 2207/30204

(57) ABSTRACT

Systems and techniques are described for surveying devices. For example, an apparatus can obtain, from at least one camera sensor while the at least one camera sensor is traveling along a path, a plurality of images comprising a plurality of devices. Each image is obtained from a respective position of the at least one camera sensor along the path. Each device of the plurality of devices includes a respective visual marker. The apparatus can detect visual markers of the plurality of devices in the plurality of images and can determine an arrangement of the visual markers detected in the plurality of images. The apparatus can pair, based on aligning the arrangement of the visual markers with a first map comprising a corresponding arrangement of a plurality of objects, a respective object of the plurality of objects to each device of the plurality of devices.

### FIELD

The present disclosure generally relates to surveying devices (e.g., tags or peripheral devices). For example, aspects of the present disclosure relate to a fast tag survey using visual markers.

### BACKGROUND

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include peripheral devices or tags, which are devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for surveying devices (e.g., tags or peripheral devices). In some aspects, an apparatus for surveying devices is provided. The apparatus includes at least one memory and at least one processor coupled to the at least one memory and configured to: obtain, from at least one camera sensor while the at least one camera sensor is traveling along a path, a plurality of images including a plurality of devices, wherein each image of the plurality of images is obtained from a respective position of the at least one camera sensor along the path, and wherein each device of the plurality of devices includes a respective visual marker; detect visual markers of the plurality of devices in the plurality of images; determine an arrangement of the visual markers detected in the plurality of images; and pair, based on aligning the arrangement of the visual markers with a first map including a corresponding arrangement of a plurality of objects, a respective object of the plurality of objects to each device of the plurality of devices.

In some aspects, a method for surveying devices is provided. The method includes: obtaining, from at least one camera sensor while the at least one camera sensor is traveling along a path, a plurality of images including a plurality of devices, wherein each image of the plurality of images is obtained from a respective position of the at least one camera sensor along the path, and wherein each device of the plurality of devices includes a respective visual marker; detecting visual markers of the plurality of devices in the plurality of images; determining an arrangement of the visual markers detected in the plurality of images; and pairing, based on aligning the arrangement of the visual markers with a first map including a corresponding arrangement of a plurality of objects, a respective object of the plurality of objects to each device of the plurality of devices.

In some aspects, a non-transitory computer-readable medium having stored thereon instructions that, when executed by at least one processor, cause the at least one processor to: obtain, from at least one camera sensor while the at least one camera sensor is traveling along a path, a plurality of images including a plurality of devices, wherein each image of the plurality of images is obtained from a respective position of the at least one camera sensor along the path, and wherein each device of the plurality of devices includes a respective visual marker; detect visual markers of the plurality of devices in the plurality of images; determine an arrangement of the visual markers detected in the plurality of images; and pair, based on aligning the arrangement of the visual markers with a first map including a corresponding arrangement of a plurality of objects, a respective object of the plurality of objects to each device of the plurality of devices.

In some aspects, an apparatus for surveying devices is provided. The apparatus includes: means for obtaining, from at least one camera sensor while the at least one camera sensor is traveling along a path, a plurality of images including a plurality of devices, wherein each image of the plurality of images is obtained from a respective position of the at least one camera sensor along the path, and wherein each device of the plurality of devices includes a respective visual marker; means for detecting visual markers of the plurality of devices in the plurality of images; means for determining an arrangement of the visual markers detected in the plurality of images; and means for pairing, based on aligning the arrangement of the visual markers with a first map including a corresponding arrangement of a plurality of objects, a respective object of the plurality of objects to each device of the plurality of devices.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a diagram illustrating an example of a system including a plurality of devices, in accordance with aspects of the present disclosure.

FIG. 4 is a signaling diagram illustrating example communication transmissions, in accordance with some aspects of the present disclosure.

FIG. 5 is a signaling diagram illustrating an example of communication transmissions between a network device and two groups of tags, in accordance with some aspects of the present disclosure.

FIG. 6 is a diagram illustrating an example of a system for surveying tags, in accordance with some aspects of the present disclosure.

FIG. 7 is a diagram illustrating an example of tag with displays displaying different identifying markers, in accordance with some aspects of the present disclosure.

FIG. 8 is a diagram illustrating an example of a planogram for arranging objects on a shelving unit in a store, in accordance with some aspects of the present disclosure.

FIG. 9 is a functional block diagram illustrating an example of a process for surveying tags, in accordance with some aspects of the present disclosure.

FIG. 10 is a diagram illustrating an example of a process for detecting visual markers of tags, in accordance with some aspects of the present disclosure.

FIG. 11 is a diagram illustrating an example of a process for aligning visual markers of tags to a planogram, in accordance with some aspects of the present disclosure.

FIG. 12 is a diagram illustrating an example of a process for mapping a planogram to a store layout, in accordance with some aspects of the present disclosure.

FIG. 13 is a diagram illustrating examples of a standalone tag and a tag rail including a plurality of tags, in accordance with some aspects of the present disclosure.

FIG. 14 is a flow diagram illustrating an example of a process for surveying tags, in accordance with some aspects of the disclosure.

FIG. 15 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Short range wireless communication protocols enable wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHZ. BLUETOOTH® Low Energy (BLE) is a form of BLUETOOTH® communication that allows for communication with devices that operate using low power. Such devices may include peripheral devices or tags, which are devices that can use low-energy communication technology for positioning, proximity marketing, or other purposes.

A system may include one or more tags or peripheral devices that are controlled by a network entity. For example, a system including for managing multiple tags or peripheral devices (e.g., an electronic shelf label (ESL) system, an electronic tag (e-tag) system, etc.) may include one or more tags or peripheral devices (e.g., ESLs, e-tags, etc.) that are controlled by a network entity, such as a management entity (ME) or edge server, via at least one network device, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device). The terms peripheral device and tag can be used interchangeably herein, and can include ESLs, e-tags, or other peripheral device.

In one or more examples, to facilitate control by the ME (e.g., edge server), each tag (e.g., ESL, c-tag, etc.) may have a wireless connection (e.g., a BLE connection or other connection) to an AP that is communicatively connected to the ME (e.g., via the Internet, such as wirelessly, via an Ethernet connection, etc.). In some cases, commands from the ME may be wirelessly transmitted to the tags by the AP. Responses or information from the peripheral devices may also be received by the AP and provided by the AP to the ME.

In peripheral systems (e.g., ESL systems, e-tag systems, etc.), periodic Advertisements (PAs) can be utilized to provide regular and predictable payload transmissions from a central device (e.g., which may be in the form of a network device, such as an AP) to one or more tags or peripheral devices. For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for peripheral systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to tags or peripheral devices in a particular group may be a PA containing a synchronization message transmitted by the central device on the synchronized channel to the peripheral devices of the particular group. For example, tags or peripheral devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

Each access point may have an associated channel map. A channel map is a listing of frequency channels to be utilized or, conversely, not to be utilized (e.g., in the context of modification of frequency hopping sequences) by an access point for communication, such as with the tags or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the tags. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more tags of the new channel map to be used for future communications with the access point.

In some cases, a tag may lose synchronization with (e.g., due to being out of communications range) a current access point for which the tag is associated. Such a loss in synchronization may interrupt the management entity's ability to control the tag and the tag's ability to report to the management entity. After determining a network outage (e.g., caused by the loss of synchronization), the tag may perform an onboarding procedure to reestablish synchronization with an access point. PAwR allows BLE tags or peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and tags (e.g., ESLs, c-tags, etc.) can act as peripheral devices. When the tags are powered, the tags can scan to receive a wake up packet (WUP) from the access point. The WUP can contain advertisement parameters for the tags. Upon receiving the WUP from the access point, the tags can transmit advertisement messages (e.g., a connectable advertisement (CAP)) on a legacy channel based on parameters (e.g., interval and duration parameters) received within the WUP. The access point can scan to receive the CAPs from the tags, and then create a generic attribute profile (GATT) connection with one of the advertising tags to perform onboarding of that tag. The onboarding process involves the transfer of periodic advertisement synchronization transfer (PAST) information, where an access point can share its PAwR timing with the tag. When multiple access points receive a CAP from an tag, the access points can report the received CAP to the management entity. The management entity can then shortlist one of the access points to onboard the tag.

A system, such as in a retail store or warehouse environment, may include one or more tags or peripheral devices (e.g., ESLs, e-tags, etc.) that are controlled by a network entity (e.g., a management entity, which may be in the form of an edge server) via at least one network device (e.g., an access point). In one or more examples, to facilitate control by the network entity (e.g., the edge server), each tag (e.g., ESL) may have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., an edge server) may be wirelessly transmitted to the tag by the network device (e.g., the access point). Responses or information from the tags may also be received by the network device, and provided by the network device to the network entity (e.g., by the access point to the edge server). One or more of the tags can each be attached to a shelf of a shelving unit (e.g., within the store or warehouse). The network entity (e.g., edge server) may store and maintain a database of information pertaining to the one or more tags.

Tag or peripheral devices (e.g., ESLs, e-tags, etc.) are becoming prolific in stores. A tag-to-object mapping can indicate which tag is associated with a particular object (e.g., product). Knowing tag-to-object mappings within a store can be vital for a retailer to be able to display on a tag (e.g., on a display of an ESL) the correct object (e.g., product) information. When tags are being installed (e.g., for the first time installed on a shelf) or when objects associated with tags are moved around, each of the tags needs to be associated with an object to generate the tag-to-object mapping. Currently, associating a tag with an object (e.g., a product) typically requires a double scan process (e.g., requiring a scan of the tag and a scan of the associated object) that is manual and is likely to have some human error introduced. Removing the need to scan every barcode (e.g., typically, there can be over 100,000 barcodes within a store) twice, can provide a huge savings in time and effort during the installation of the tags, and can also reduce any possible errors from occurring while updating the locations. In one or more cases, tags can be used to locate objects (e.g., products, users, devices, and/or assets). To greatly improve the location estimate (e.g., boost the position accuracy), the precise locations of the tags are needed. Currently, a manual process, which can be time consuming and laborious, is generally employed to map a Bluetooth address (e.g., associated with a tag) to an object identification (ID) of an object.

As such, improved systems and techniques for a fast survey of tags to associate tags with objects (e.g., products) and to obtain locations of the tags can be beneficial.

In one or more aspects of the present disclosure, systems, apparatuses, methods (also referred to as processes), and computer-readable media (collectively referred to herein as “systems and techniques”) are described herein that provide solutions for a fast tag survey (e.g., a fast ESL survey, fast e-tag survey, etc.) using visual markers that can map (e.g., pair) tags to objects (e.g., products) and can obtain locations of the tags. In one or more examples, the systems and techniques provide a single sweep survey process for tags that uses vision and reliable visual marker detection. The single sweep survey process removes the need for double scans and allows for a quick and easy determination of locations of large quantities of tags.

Various aspects relate generally to surveying tags or peripheral devices (e.g., ESLs, c-tags, etc.). Some aspects more specifically relate to systems and techniques that provide solutions for a visual system, where tags can update their displays, which may be in the form of electronic ink (e-ink) screens, to display visual markers, which may be in the form of fiducial markers that are unique. For example, an ESL displaying on its display a barcode and/or a quick response (QR) code can update its display to display a visual marker in the form of a more easily detectable (e.g., by vision) fiducial marker. This display update can consume tag battery power. Alternatively, tags (e.g., ESLs, c-tags, etc.) with visual markers may be added to device rails (e.g., tag rails) that display visual markers. The implementation of tags into these tag rails can avoid the need for a display update and, as such, can conserve tag battery power (e.g., battery power of an ESL, e-tag, etc.).

In one or more aspects, the systems and techniques provide a vision system, where a camera, moving along a path with known ground truth locations, can use vision (e.g., capture images) to detect visual markers displayed on displays of tags and to measure (e.g., determine the line of sight, angles, depth, and/or distance to) the visual markers. The locations of the tags can be determined (e.g., by using triangulation) based on the ground truth locations and the measurements of the detected visual markers. A tag-to-object (e.g., product) mapping and locations of the tags can be determined based on (e.g., by using) a determined arrangement of the tags and some additional information (e.g., determined locally or received from another entity, such as a building owner, a retailer, etc.), such as a planogram and a building layout (e.g., a store layout). In one or more examples, the systems and techniques can employ additional techniques to detect any tags that were missed (e.g., not detected during the single sweep).

In one or more aspects, during operation for surveying tags, a camera sensor, while traveling along a path, can obtain a plurality of images including a plurality of tags. In one or more examples, each image of the plurality of images can be obtained from a respective position of the camera sensor along the path. In some examples, each tag of the plurality of tags can include a respective visual marker. One or more processors can detect visual markers of the plurality of devices in the plurality of images and can determine an arrangement of the visual markers detected in the plurality of images. The one or more processors can pair, based on aligning the arrangement of the visual markers with a first map comprising a corresponding arrangement of a plurality of objects, a respective object of the plurality of objects to each tag of the plurality of tags.

In one or more examples, the arrangement of the visual markers can include a respective height of each of the visual markers, and an order of the visual markers for each of the respective heights. In some examples, the respective height for each of the visual markers can correspond to a respective shelf of a shelving unit associated with the first map. In one or more examples, the first map can be a planogram for the plurality of objects.

In some examples, the one or more processors can determine, based on mapping the first map to a second map including known locations on the path, a respective location of each tag of the plurality of tags. In one or more examples, determining the respective location of each tag of the plurality of tags can be further based on performing triangulation using lines of sight from the known locations on the path to the visual markers in the images. In some examples, the respective location of each tag of the plurality of tags can include coordinates in a real-world space. In one or more examples, the second map can be a building layout. In some examples, the building layout can be a store layout or a warehouse layout. In one or more examples, each visual marker of the visual markers can be a fiducial marker. In some examples, two or more tags of the plurality of tags can be mounted on a tag rail. In one or more examples, the plurality of objects includes a plurality of products. In some examples, each tag of the plurality of tags can be an ESL, an e-tag, or other type of tag or peripheral device.

Particular aspects of the subject matter described in this disclosure can be implemented to realize one or more of the following potential advantages. In one or more examples, the systems and techniques can provide the benefit of providing a fast single sweep survey process that removes the need for the currently employed slow and laborious double scan process that requires scanning both a tag and its associated object (e.g., product). In some examples, the systems and techniques can provide the benefit of providing a process that can be automated by being performed by a camera mounted on a robot moving throughout aisles within a store. In one or more examples, the systems and techniques can provide the benefit of removing any possible human errors that may occur during the process since the process can be automated. In some examples, the systems and techniques can provide the benefit of preventing unnecessary tag battery power consumption when a tag display update is not needed.

Additional aspects of the present disclosure are described in more detail below.

As used herein, the term “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

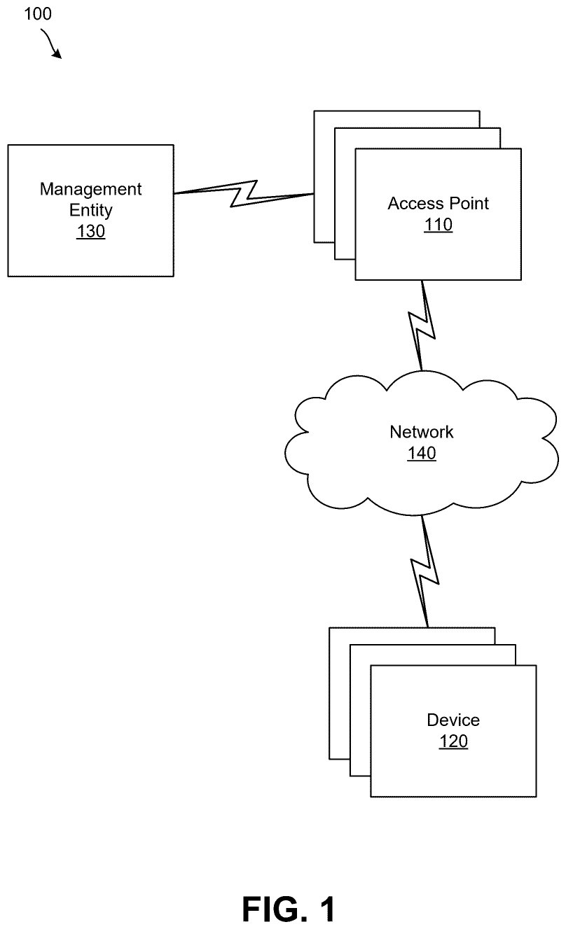

According to various aspects, FIG. 1 is a diagram of an example environment 100 in which systems and/or methods described herein may be implemented. As shown in FIG. 1, the environment 100 may include at least one access point (AP) 110 (e.g., a network device), at least one device 120 (e.g., a tag, peripheral device, wireless communication device, or other device), a management entity (ME) 130 (e.g., a network entity), and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The device 120 may include one or more devices capable of receiving, generating, storing, processing, and/or providing information associated with access point synchronization and/or handover, as described elsewhere herein. The device 120 may include a communication device and/or a computing device. In some aspects, the device 120 may be, may include, or may be included in a tag (or peripheral device), such as an ESL, an e-tag, a wireless communication device, or other type of device.

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., a tag system) that includes the access point(s) 110, the device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

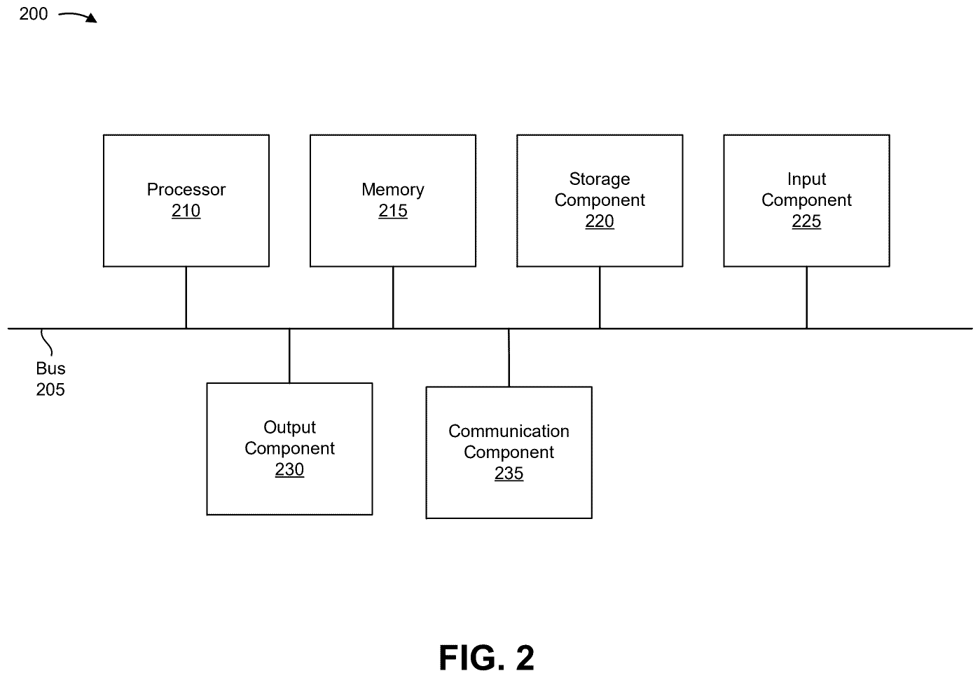

FIG. 2 is a diagram illustrating example components of a device 200, in accordance with the present disclosure. Device 200 may correspond to access point 110, device 120 (e.g., a tag), and/or management entity 130. In some aspects, access point 110, device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent a tag (e.g., an ESL, an e-tag, etc.). The tag may include a battery in addition to the aforementioned components. In some aspects, the output component 230 of the tag may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

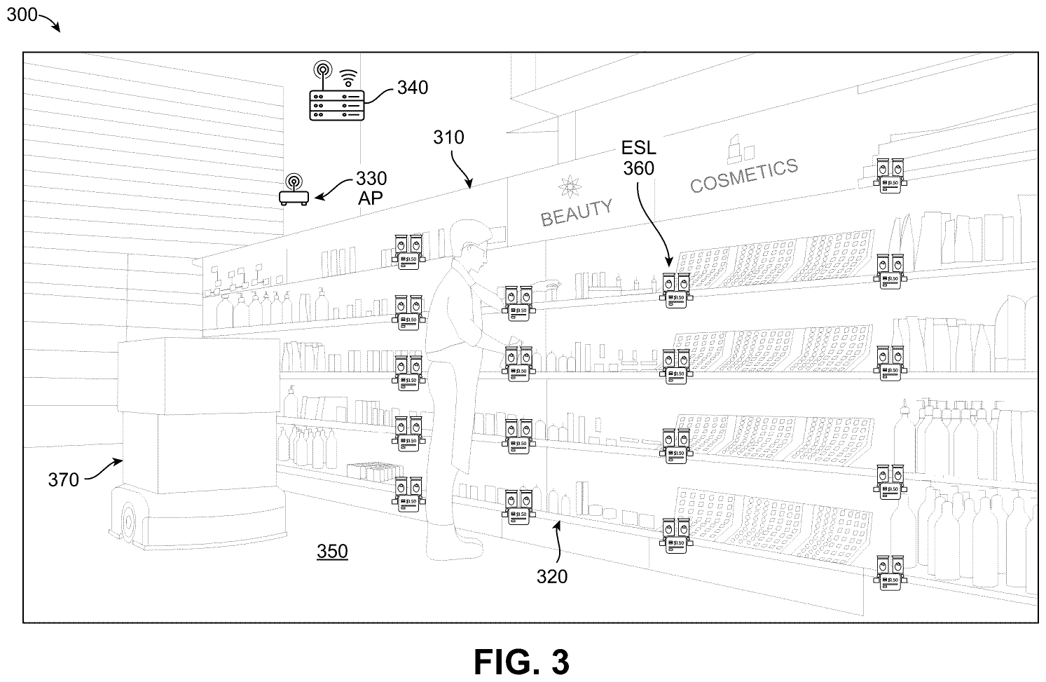

As previously mentioned, a system, such as in a retail store or warehouse environment, can include one or more devices that are controlled by a network entity. For example, a system may include one or more tags or peripheral devices (e.g., ESLs, c-tags, etc.) that are controlled by a network entity (e.g., a management entity, which may be in the form of an edge server, such as network entity 340 of FIG. 3) via at least one network device (e.g., an access point, such as access point 110 of FIG. 1). In one or more examples, to facilitate control by the network entity (e.g., the edge server), each tag can have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the edge server) can be wirelessly transmitted to the tags by the network device (e.g., the access point). Responses or information from the tags can also be received by the network device, and provided by the network device to the network entity (e.g., by the access point to the edge server). One or more of the tags can each be attached to a shelf of a shelving unit (e.g., within the store or warehouse). The network entity (e.g., edge server) may store and maintain a database of information pertaining to the one or more tags.

FIG. 3 shows an example of system. In particular, FIG. 3 is a diagram illustrating an example of a system 300. In FIG. 3, the system 300 is shown to be located within a retail store. The system 300 is shown to include a network entity 340 (e.g., in the form of an edge server or gateway node, which may be located within the retail store), a network device 330 (e.g., an access point, which may be located within the retail store), and devices 360 (e.g., in the form of tags or peripheral devices, such as ESLs, e-tags, etc.).

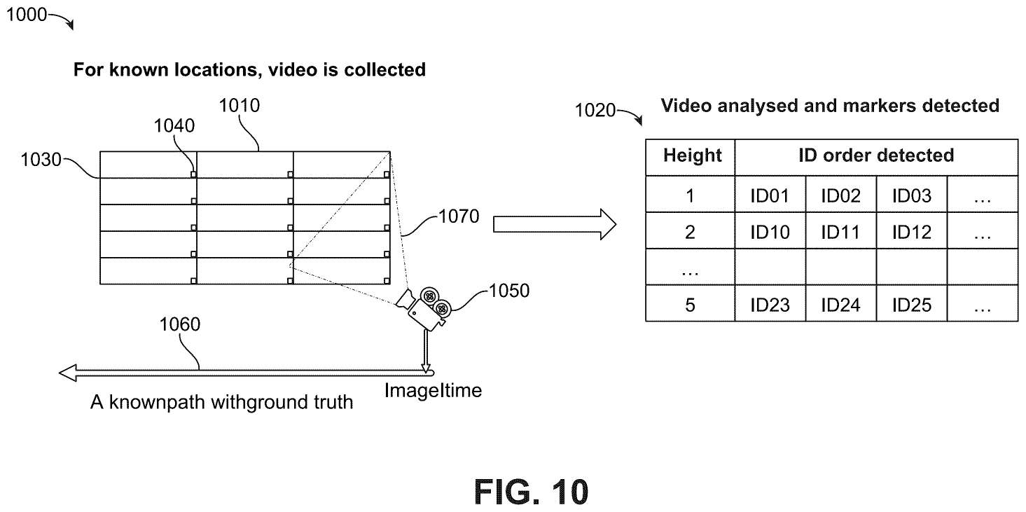

In one or more examples, the devices 360 may be mounted on shelves (e.g., shelves 320) of shelving units (e.g., shelving unit 310) located within the store. In some examples, the devices 360 may be powered and/or controlled by an electric rail mounted within the shelves (e.g., shelves 320) of the shelving units (e.g., shelving unit 310). In one or more examples, the system 300 may employ a robot 370 that may move along the aisles (e.g., aisle 350) located between the shelving units (e.g., shelving unit 310) within the store. In some examples, a reader (e.g., a tag reader or scanner, such as an ESL, e-tag, or other tag reader or scanner) and/or a camera (e.g., camera 1050 of FIG. 10) may be mounted onto the robot.

In one or more aspects, the devices 360 (e.g., tags) may have a capability to support radio communications, such as radio frequency (RF) communications (e.g., using cellular, satellite, Wi-Fi, and/or Bluetooth communications). For example, the devices 360 may be able to receive transmissions (e.g., RF signal transmissions) from a network device 330 (e.g., access point) and to transmit (e.g., RF signal transmissions) to the network device 330 (e.g., access point). The network device 330 (e.g., access point) can then relay information within the transmissions received from the devices 360 to the network entity 340 (e.g., edge server) for processing.

As previously mentioned, in tag systems (e.g., ESL systems, e-tag systems, etc.), PAs are often utilized to provide regular and predictable payload transmissions from a central device (e.g., which may be in the form of a network device, such as an access point) to one or more tags or peripheral devices (e.g., an ESL, e-tag, etc.). PAs can be used to issue information from a central device to multiple tags, which may be within one or more groups of tags. PAs are generally unidirectional (e.g., unidirectional transmissions) such that PAs are transmitted only one-way from a central device to one or more tags.

Periodic Advertisement with Response (PAwR) was introduced to tag/peripheral systems (e.g., ESL systems) to provide bidirectionality (e.g., bidirectional transmissions between a central device and one or more tags). Peripheral devices synchronized within a group of tags can be addressed by a central device on a synchronized channel (e.g., a synchronized frequency channel between the central device and the tags) whenever the central device determines to send (e.g., transmit) a request (e.g., a PA containing a synchronization message transmitted on the synchronized channel) to the tags. If a response from a tag is expected by the central device (e.g., the synchronization message from the central device requests a response from a specific tag), the particular tag will respond in a specific response slot, based on where the tag appeared within a sequence contained within the synchronization message transmitted by the central device.

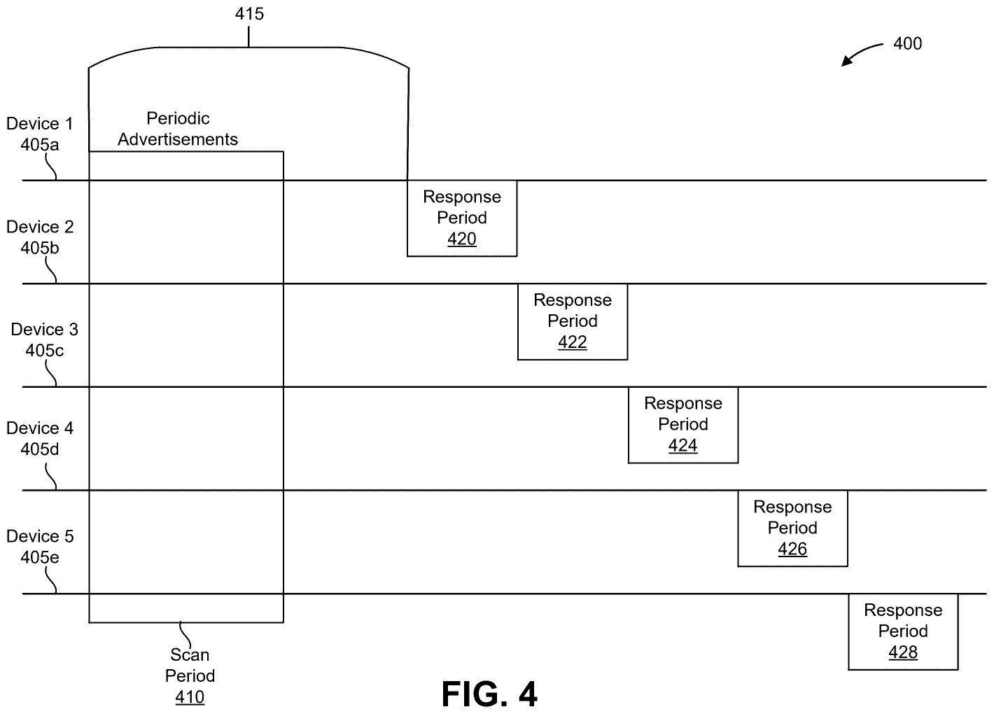

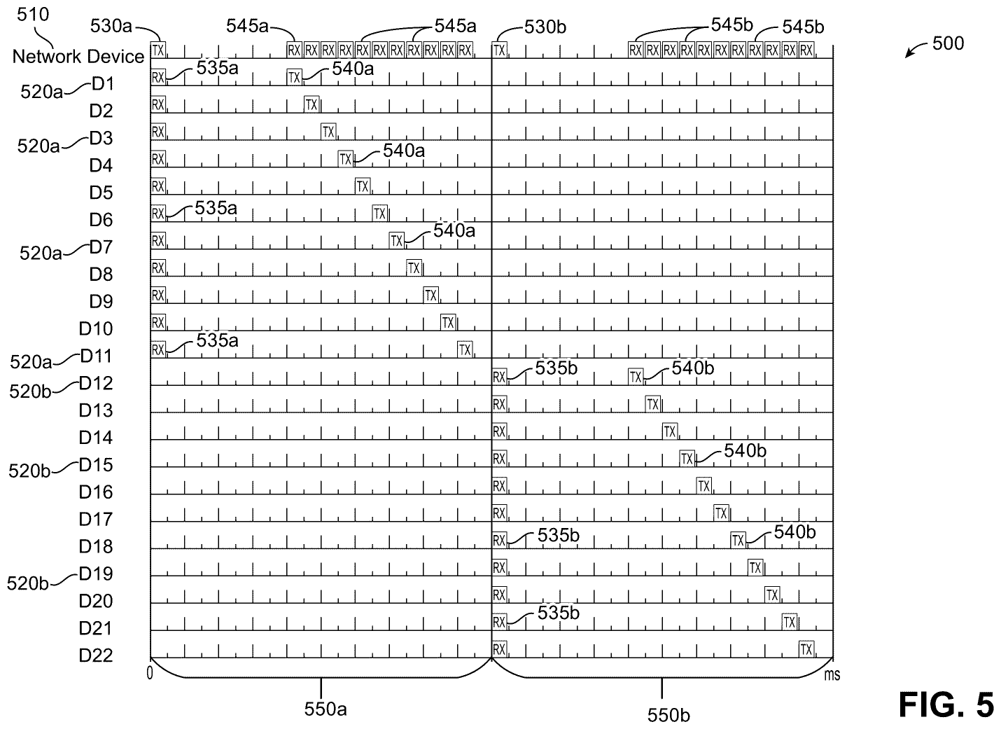

FIGS. 4 and 5 show signaling diagrams illustrating examples of PAwR in a tag/peripheral system. The tag/peripheral system may be an ESL system, an e-tag system, or other system including tags/peripheral devices. In particular, the signaling diagram of FIG. 4 shows an example PAwR for a group of wireless network devices (e.g., device 1 405a, device 2 405b, device 3 405c, device 4 405d, and device 5 405c), and the signaling diagram of FIG. 5 shows an example PAwR for two groups of wireless network devices 520a, 520b (e.g., a first group including tag 1 to tag 11, and a second group including tag 12 to tag 22). Specifically, FIG. 4 is a signal timing diagram illustrating a portion of a communication between an access point (e.g., access point 110) and devices 120 (e.g., ESLs, e-tags, etc.). With reference to FIG. 1, the signal sequence illustrated in FIG. 4 may be implemented by one or more of the communication connections, access points 110, and/or devices 120 of FIG. 1.

The devices (e.g., device 1 405a, device 2 405b, device 3 405c, device 4 405d, and device 5 405c) of FIG. 4 may be selected from devices 120 of FIG. 1, and may each receive a periodic advertisement (PA) in a scan period 410. The scan period 410 may occur in regularly scheduled intervals and may be repeated periodically such that the devices (e.g., device 1 405a, device 2 405b, device 3 405c, device 4 405d, and device 5 405c) can awaken to scan for messages during this repeated scan period 410. An access point (e.g., access point 110 of FIG. 1) may provide periodic advertisements (PAs) via broadcast or multi-cast to the devices (e.g., device 1 405a, device 2 405b, device 3 405c, device 4 405d, and device 5 405c) in the scan period 410. For an access point (e.g., access point 110 of FIG. 1), the scan period 410 can be its primary transmission period. In some cases, the scan period 410 may not be a fixed time because the access point (e.g., access point 110 of FIG. 1) may send different lengths of data from the start of the scan period 410.

The transmission may include multiple advertisements in a train. One or more portions of the advertisements may be directed to one or more of the devices (e.g., device 1 405a, device 2 405b, device 3 405c, device 4 405d, and device 5 405c). The devices (e.g., device 1 405a, device 2 405b, device 3 405c, device 4 405d, and device 5 405c) may decode or filter the messages intended for each specific device and transmitted during the period when all devices are receiving. In this way, the devices (e.g., device 1 405a, device 2 405b, device 3 405c, device 4 405d, and device 5 405c) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 405a, device 2 405b, device 3 405c, device 4 405d, and device 5 405c).

As illustrated, the devices (e.g., device 1 405a, device 2 405b, device 3 405c, device 4 405d, and device 5 405c) are each assigned a response period 420, 422, 424, 426, 428 in the time after the scan period 410. The response periods 420, 422, 424, 426, 428 for the tag transmissions occur in a time division multiple access (TDMA) manner. In some cases, the assignment of the response period to a particular device may not be permanent. In some aspects, the assignment may be inferred from a payload of a synchronization message. The first response period 420 may begin following an idle time 415 after the scan period 410, with the idle period being long enough to provide the transmitter device an opportunity to do other Bluetooth related activities. The assigned response periods may also be limited to or designate a particular frequency of the channels on which to respond. For example, in FIG. 4, device 1 405a is assigned response period 420, device 2 405b is assigned response period 422, device 3 405c is assigned response period 424, device 4 405d is assigned response period 426, and device 5 405e is assigned response period 428. The access point (e.g., access point 110 of FIG. 1) may store attributes of the devices (e.g., device 1 405a, device 2 405b, device 3 405c, device 4 405d, and device 5 405c), including whether a device is able to transmit or respond. The PA signaling followed by responses can be referred to as periodic advertisement with multiple responses (PAwMR).

For example, device 3 405c (e.g., device 120 of FIG. 1) may be tag (e.g., an ESL, an e-tag, or other type of tag or peripheral device) and may receive a price update in a PA from the access point (e.g., access point 110 of FIG. 1) in scan period 410. The PA received at device 3 405c may include a designated start time for the response period 424 or may include a schedule of response start times for devices including device 3 405c. The response by device 3 405c to the access point (e.g., access point 110 of FIG. 1) may include an acknowledgement, a status code, and/or other information such as battery life, received signal strength, and/or an error notification. The response by device 3 405c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 405a, device 2 405b, device 3 405c, device 4 405d, and device 5 405c) may use channels of the Bluetooth protocol.

A device (e.g., device 5 405c) that has been assigned a response period may not respond and may determine that it has nothing to signal. In other words, the devices (e.g., device 1 405a, device 2 405b, device 3 405c, device 4 405d, and device 5 405e) may determine what response, if any, is required and may or may not respond to a request sent from the access point (e.g., access point 110 of FIG. 1). The response periods 420, 422, 424, 426, 428 may be assigned based on a request for such a period in an open transmission time, the request being sent to the access point (e.g., access point 110 of FIG. 1). The response periods 420, 422, 424, 426, 428 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 5 shows an example PAwR for two groups of wireless network devices 520a, 520b (e.g., a first group including tag 1 to tag 11, and a second group including tag 12 to tag 22). In particular, FIG. 5 is a signaling diagram illustrating an example of communication transmissions 500 between a network device 510 (e.g., a central device, which may be an access point) and two groups of devices 520a, 520b (e.g., tags peripheral devices, such as ESLs, e-tags, etc.). With reference to FIG. 1, the signal sequence illustrated in FIG. 5 may be implemented by one or more of the communication connections, access points 110, and/or wireless communication devices 120 of FIG. 1.

In FIG. 5, the signaling diagram is shown in the form of a graph (e.g., a time grid, which may be predetermined) with an x-axis denoting time in milliseconds (ms) and a y-axis denoting specific devices 520a, 520b (e.g., denoted as device 1 (D1) through device 22 (D22), which can include tag 1, tag 2, tag 3, tag 4, tag 5, tag 6, tag 7, tag 8, tag 9, tag 10, tag 11, tag 12, tag 13, tag 14, tag 15, tag 16, tag 17, tag 18, tag 19, tag 20, tag 21, and tag 22). In particular, the x-axis of the graph of FIG. 5 denotes time starting from zero (0) ms. The time can be divided into two subframes 550a, 550b. As such, the two subframes 550a, 550b may include a first subframe 550a and a second subframe 550b. In one or more examples, there may be more or less than two subframes 550a, 550b as is shown in FIG. 5, and/or each subframe 550a, 550b may be longer or shorter than as shown in FIG. 5.

In one or more examples, the devices 520a, 520b (e.g., tags) may be assigned (e.g., by the network device 510 and/or by a network entity, such as a management entity) to different groups (e.g., two groups) of devices 520a, 520b. For example, devices 520a (e.g., tag 1, tag 2, tag 3, tag 4, tag 5, tag 6, tag 7, tag 8, tag 9, tag 10, and tag 11) may be assigned to a first group (e.g., group 1), and devices 520b (e.g., tag 12, tag 13, tag 14, tag 15, tag 16, tag 17, tag 18, tag 19, tag 20, tag 21, and tag 22) may be assigned to second group (e.g., group 2).

In FIG. 5, during operation for PAwR, at time 0 ms for the first subframe 550a of time, the network device 510 (e.g., a central, such as an AP) may transmit 530a to a first group (e.g., group 1) of devices 520a (e.g., tag 1, tag 2, tag 3, tag 4, tag 5, tag 6, tag 7, tag 8, tag 9, tag 10, and tag 11) a PA containing a synchronization message (e.g., an AP synchronization message) over a synchronized channel between the network device 510 and the devices 520a, 520b. As noted previously, a synchronization message can include one or more commands. For instance, a command can include an operational code (OpCode) and parameters associated with the command. At time 0 ms, the first group of devices 520a (e.g., tag 1, tag 2, tag 3, tag 4, tag 5, tag 6, tag 7, tag 8, tag 9, tag 10, and tag 11) can receive 535a the PA containing the synchronization message over the synchronized channel.

In one or more examples, the network device 510 may be configured to transmit PAS at a specified time interval (e.g., a subframe of time), such as is shown in FIG. 5. In one or more examples, the specified time interval (e.g., a subframe) may be shorter or longer than the as is shown in FIG. 5. The devices 520a, 520b may respond to a PA by using their specific respective response slot in time.

In one or more examples, the synchronization message transmitted 530a to the first group (e.g., group 1) of devices 520a (e.g., tag 1, tag 2, tag 3, tag 4, tag 5, tag 6, tag 7, tag 8, tag 9, tag 10, and tag 11) may indicate a respective response slot for one or more of the devices 520a (e.g., tag 1, tag 2, tag 3, tag 4, tag 5, tag 6, tag 7, tag 8, tag 9, tag 10, and/or tag 11) in the first group to use to transmit 540a a response to the network device 510. If a device 520a (e.g., tag 1, tag 2, tag 3, tag 4, tag 5, tag 6, tag 7, tag 8, tag 9, tag 10, and tag 11) is addressed within the synchronization message, the device 520a (e.g., tag 1, tag 2, tag 3, tag 4, tag 5, tag 6, tag 7, tag 8, tag 9, tag 10, and tag 11) can respond (e.g., transmit 540a) in its respective response slot, as indicated within the synchronization message. For example, the synchronization message may indicate a specific sequence for one or more of the devices 520a (e.g., tag 1, tag 2, tag 3, tag 4, tag 5, tag 6, tag 7, tag 8, tag 9, tag 10, and/or tag 11) to respond (e.g., transmit 540a) in time (e.g., responding after 5 ms has elapsed after the start of the subframe 550a at response slots as shown in FIG. 5).

After the devices 520a have received 535a the PA containing the synchronization message from the network device 510, according to the sequence specified within the synchronization message, the one or more devices 520a can transmit 540a their responses within their respective response slots. After the one or more devices 520a have transmitted 540a their responses in their respective response time slots, the network device 510 can receive 545a their transmitted responses at those specific response slot times.

During operation for PAwR, for the second subframe 550b of time, the network device 510 may transmit 530b to a second group (e.g., group 2) of devices 520b (e.g., tag 12, tag 13, tag 14, tag 15, tag 16, tag 17, tag 18, tag 19, tag 20, tag 21, and tag 22) a PA containing a synchronization message over a synchronized channel between the network device 510 and the devices 520a, 520b. In addition, at the start of the second subframe 550b, the second group of devices 520b (e.g., tag 12, tag 13, tag 14, tag 15, tag 16, tag 17, tag 18, tag 19, tag 20, tag 21, and tag 22) can receive 535b the PA containing the synchronization message over the synchronized channel.

The synchronization message transmitted 530b to the second group (e.g., group 2) of devices 520b may indicate a respective response slot for one or more of the devices 520b in the second group to use to transmit 540b a response to the network device 510. If a device 520b is addressed within the synchronization message, the device 520b can respond (e.g., transmit 540b) in its respective response slot, as indicated within the synchronization message. For example, the synchronization message may indicate a specific sequence for one or more of the devices 520b to respond (e.g., transmit 540b) in time (e.g., responding after 5 ms has elapsed after the start of the subframe at response slots as shown in FIG. 5).

After the devices 520b have received 535b the PA containing the synchronization message from the network device 510, according to the sequence specified within the synchronization message, the one or more devices 520b may transmit 540b their responses within their respective response slots. After the one or more devices 520b have transmitted 540b their responses in their respective response time slots, the network device 510 can receive 545b their transmitted responses at those specific response slot times. The PAwR may continue similarly for subsequent subframes of time.

As previously mentioned, ESLs are becoming prolific in retail stores. As noted previously, knowing the tag-to-object (e.g., product) mapping (e.g., pairing) within a store can be important for a retailer to be able to display on the ESLs the correct object (e.g., product) information. For example, when tags (e.g., ESLs, e-tags, etc.) are being installed (e.g., for the first time installed on a shelf) or when objects associated with tags are moved around, each of the tags needs to be paired with an object to generate the tag-to-object mapping. Associating a tag with an object (e.g., a product) currently requires a double scan process (e.g., which involves scanning the tag and scanning the corresponding object) that is manual and likely to have some human error. Removing the need to scan every barcode twice, can allow for a savings in time and effort during the installation of the tags, and can also reduce errors from occurring while updating the locations. Tags can be used to locate objects (e.g., products). To greatly improve the location estimate, the precise locations of the tags are needed. A manual process (e.g., which can be time consuming and laborious) is currently used to map a Bluetooth address (e.g., associated with a tag) to an object identification (ID) of an object (e.g., a product). Therefore, improved systems and techniques for a fast survey of tags to associate tags with objects (e.g., products) and to obtain locations of the tags can be useful.

In one or more aspects, the systems and techniques provide solutions for a fast tag survey using visual markers that can map (e.g., pair) tags to objects (e.g., products) and can obtain locations of the tags. In one or more examples, the systems and techniques provide a single sweep survey process that uses vision and reliable visual marker detection, which removes the need for double scanning and allows for a quick and easy determination of locations of large quantities of tags.

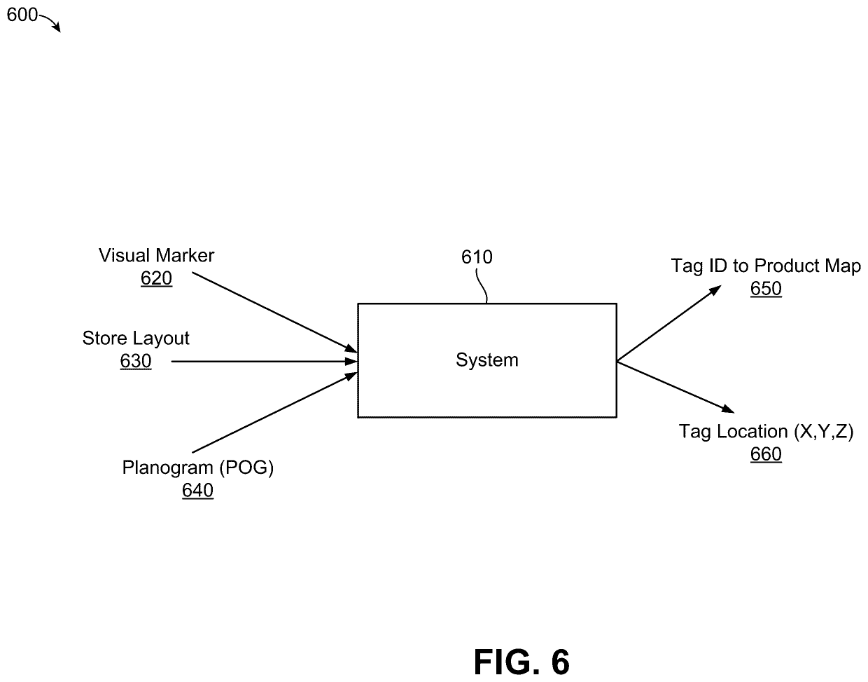

FIG. 6 is a diagram illustrating an example 600 of a system 610 for surveying devices, which may be in the form of tags or peripherals (e.g., ESLs, e-tags, etc.). In FIG. 6, visual markers 620, a store layout 630, and a planogram (POG) 640 are shown to be input into the system 610. Based on those inputs, the system 610 is shown to output a tag ID (e.g., an ESL ID) to product (e.g., object) map 650 and a tag (e.g., ESL) location 660 (e.g., in X, Y, Z coordinates).

In one or more examples, the tags can update their displays (e.g., which may be in the form of e-ink screens) to display visual markers (e.g., which may be in the form of fiducial markers that are unique and easily detectable by vision). For example, a tag displaying on its display a barcode and/or a QR code can update its display to display a visual marker in the form of a more easily detectable (e.g., by vision) fiducial marker.

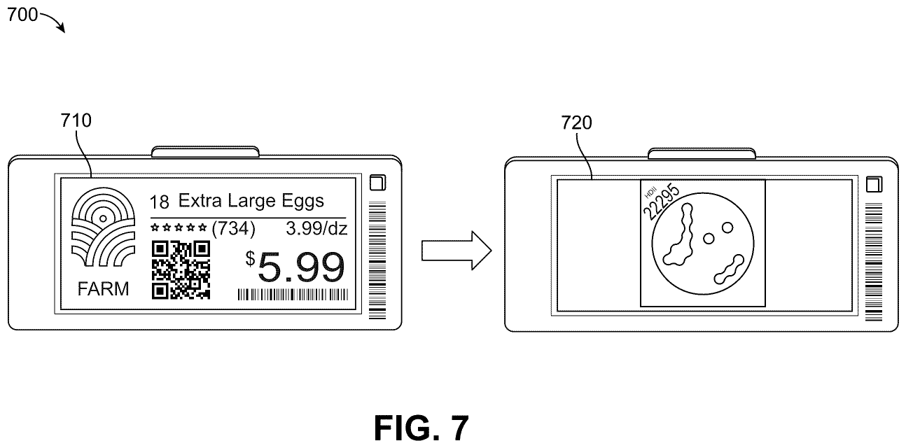

FIG. 7 shows an example of a tag display update. In particular, FIG. 7 is a diagram illustrating an example 700 of tag (e.g., an ESL, c-tag, etc.) displays displaying different identifying markers 710, 720. The identifying markers 710, 720 include a form of code that, when read, indicates one or more features (e.g., description, price, quantity, and/or brand) of associated objects (e.g., products). The identifying marker 710 of FIG. 7 is shown to include both a QR code and a bar code. In FIG. 7, the tag display is shown to be updated from the identifying marker 710 (e.g., including a QR code and a bar code) to the identifying marker 720, which includes a visual marker (e.g., in the form of a fiducial marker).

A tag display update can consume the tag battery power. Alternatively, tags with visual markers can be added to device rails (e.g., tag rails) that display visual markers. Adding tags to tag rails can avoid the need for a display update, which can prevent unnecessary usage of tag battery power. In some examples, tags with visual markers already displayed (e.g., by default) can be installed.

Referring back to FIG. 6, in one or more examples, during operation of the system 610, a camera, moving along a path with known ground truth locations, can use vision (e.g., capture images) to detect visual markers 620 (e.g., fiducial markers) displayed on tag displays and to measure (e.g., determine the line of sight, angles, depth, and/or distance to) the visual markers 620. The tag locations 660 (e.g., in X, Y, Z coordinates) can be determined (e.g., by using triangulation) based on the ground truth locations and the measurements of the detected visual markers 620. A tag ID (e.g., an ESL ID, an e-tag ID, etc.) to product (e.g., object) map 650 and the tag locations 660 can be determined based on (e.g., by using) a determined arrangement of the tags and some additional information (e.g., determined locally or received from another entity, such as a building owner, a retailer, etc.), such as a planogram (POG) 640 and a store layout 630 (e.g., a building layout). In one or more examples, the systems and techniques can employ additional techniques to detect any tags that were not detected during the single sweep.

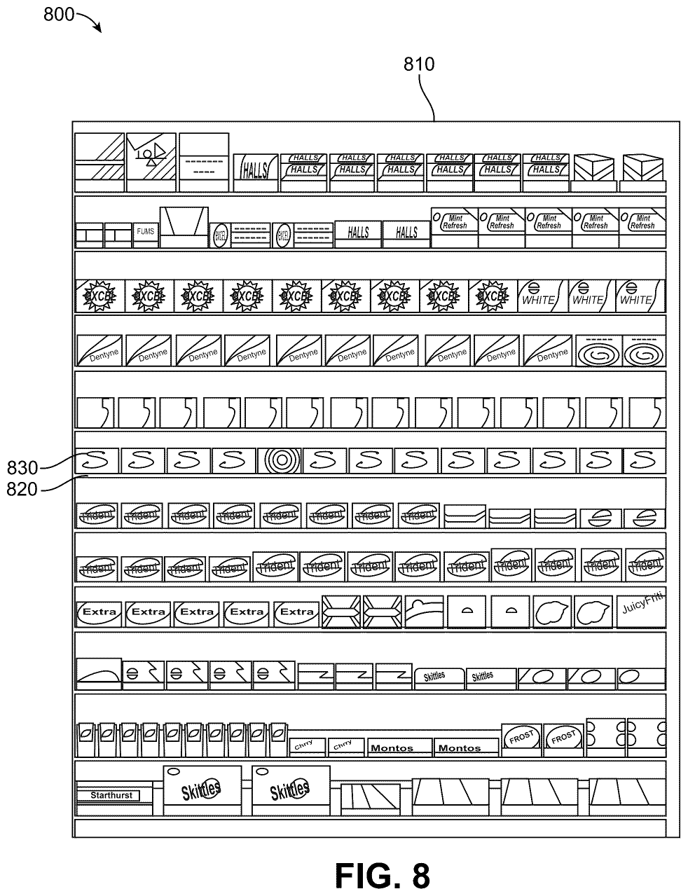

FIG. 8 shows an example planogram (POG). In particular, FIG. 8 is a diagram illustrating an example of a planogram 800 for arranging objects 830 (e.g., products) on a shelving unit 810 (e.g., of a particular aisle) in a store. A planogram 810 provides a means for visual merchandising of objects (e.g., products) by providing a plan of exactly how the different objects should be organized within a retail store. In one or more examples, a planogram 810 is a diagram or model that indicates the organization and placement of different types of objects 830 (e.g., retail products) on shelves 820 of a shelving unit 810 in a store. For example, as shown in FIG. 8, the planogram 810 can show the specific placement and order of certain types of objects 830 on the different shelves 820 of a shelving unit 810 within a store. In some examples, the planogram 810 can include details regarding the number of shelves 820, the heights of the shelves 820 (e.g., different shelves 820 can have different heights from each other), and/or the distances (spacings) between the objects (e.g., products) on the shelves 820.

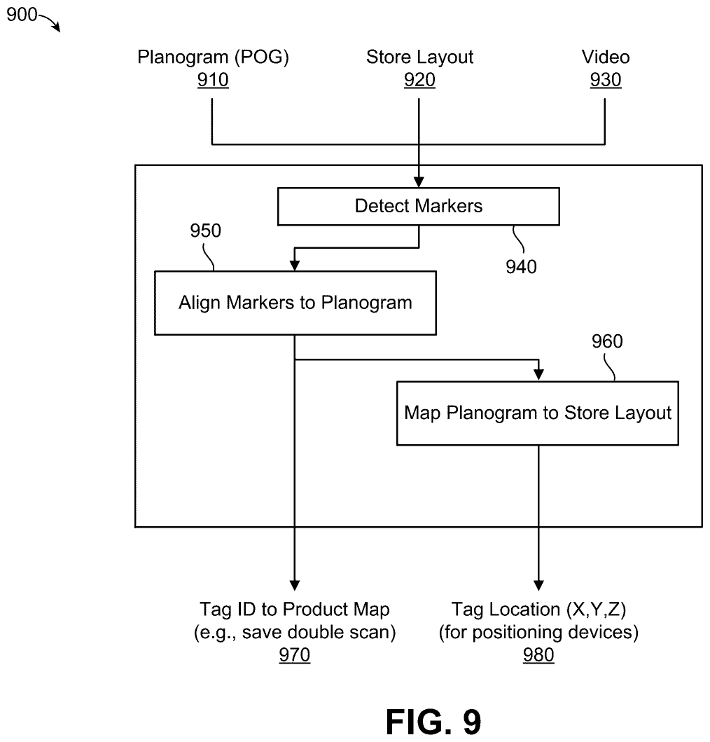

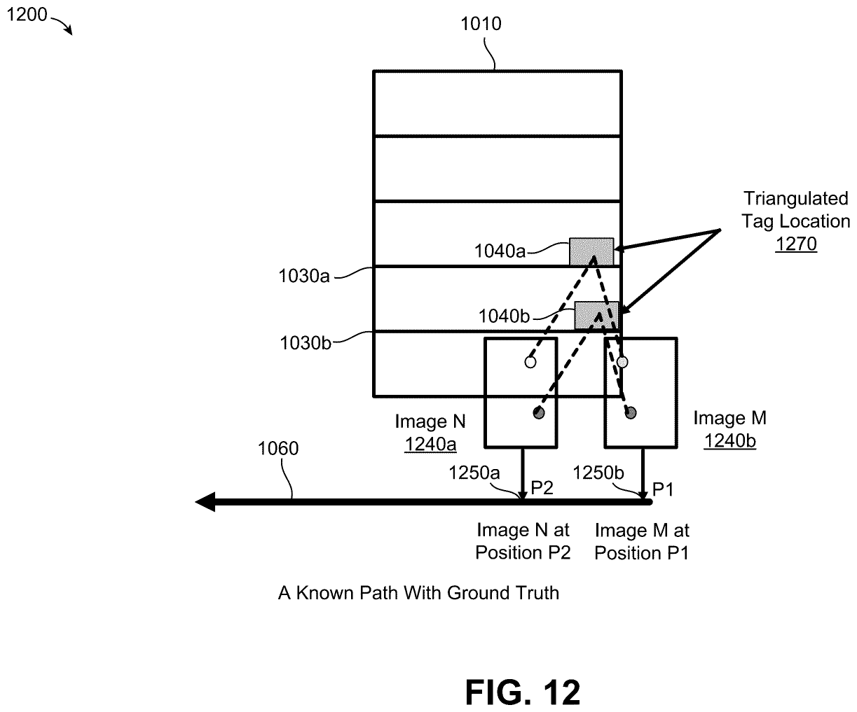

FIG. 9 shows an example process for a fast tag survey (e.g., a fast ESL survey, a fast e-tag survey, etc.) using visual markers. In particular, FIG. 9 is a functional block diagram illustrating an example of a process 900 for surveying devices (e.g., tags or peripheral devices, such as ESLs, e-tags, etc.). During operation of the process 900 for surveying devices, a camera sensor (e.g., camera 1050 of FIG. 10), while traveling along a path (e.g., path 1060 of FIGS. 10 and 12), may obtain a plurality of images (e.g., image N 1240a and image M 1240b of FIG. 12), which may be in the form of video 930, including a plurality of tags or peripheral devices (e.g., devices 1040 of FIG. 10 and/or devices 1040a, 1040b of FIG. 12, which may be in the form of tags, such as ESLs, e-tags, etc.). In one or more examples, each image of the plurality of images (e.g., image N 1240a and image M 1240b of FIG. 12) may be obtained from a respective position (e.g., position P2 1250a and position P1 1250b of FIG. 12) of the camera sensor (e.g., camera 1050 of FIG. 10) at a known location on the path (e.g., path 1060 of FIGS. 10 and 12). In some examples, each device (e.g., tag) of the plurality of devices may include a respective visual marker (e.g., identifying marker 720 of FIG. 7, which may be in the form of a fiducial marker).

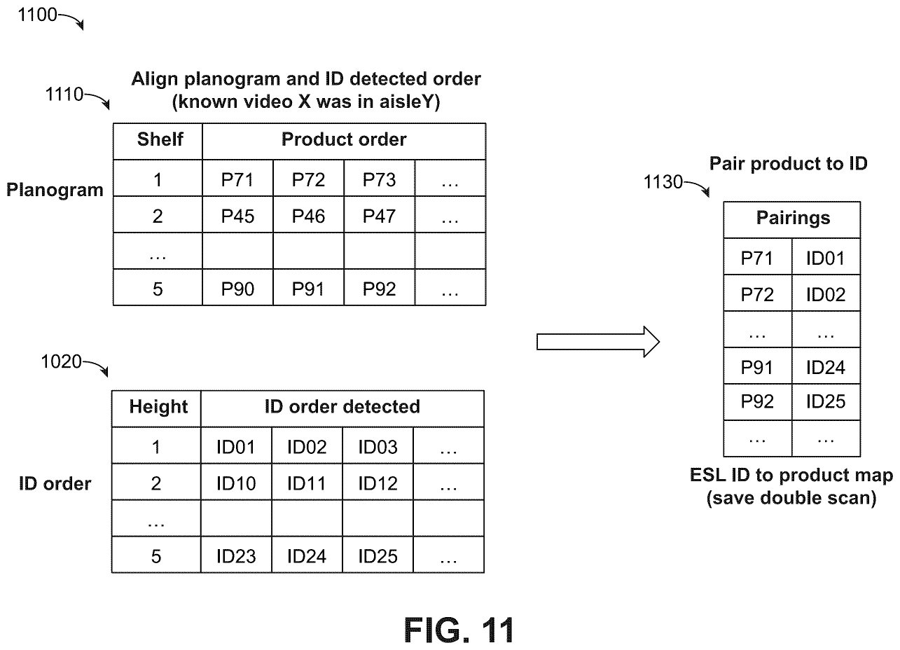

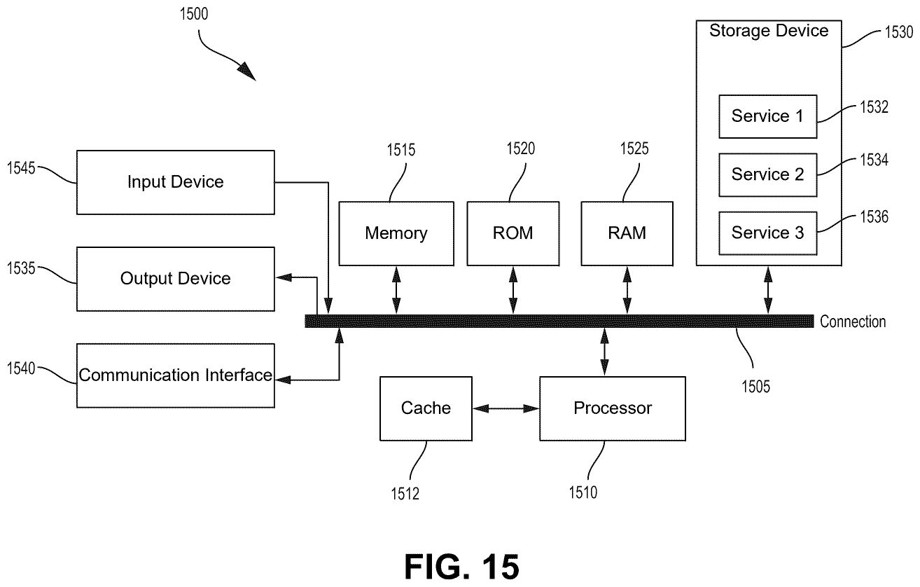

One or more processors (e.g., processor 210 of FIG. 1 and/or processor 1510 of FIG. 15) may detect, based on detecting the visual markers (e.g., at block 940) in the plurality of images, an arrangement (e.g., as shown in table 1020 of FIG. 10) of the visual markers. The one or more processors may pair, based on aligning (e.g., at block 950) the arrangement (e.g., table 1020 of FIG. 10) of the visual markers with a first map (e.g., planogram 910, such as planogram 800 of FIG. 8) comprising a corresponding arrangement of a plurality of objects (e.g., objects 830 of FIG. 8), a respective object of the plurality of objects to each device (e.g., tag) of the plurality of devices (e.g., produce a tag ID to product map 970, such as shown in table 1130 of FIG. 11).

In one or more examples, the arrangement (e.g., table 1020 of FIG. 10) of the visual markers may include a respective height of each of the visual markers, and an order of the visual markers for each of the respective heights. In some examples, the respective height for each of the visual markers may correspond to a respective shelf (e.g., shelves 820 of FIG. 8 and/or shelves 1030 of FIG. 10) of a shelving unit (e.g., shelving unit 810 of FIG. 8 and/or shelving unit 1010 of FIG. 10) associated with the first map (e.g., the planogram 910). In one or more examples, the first map may be a planogram (e.g., planogram 800 of FIG. 8) for the plurality of objects.

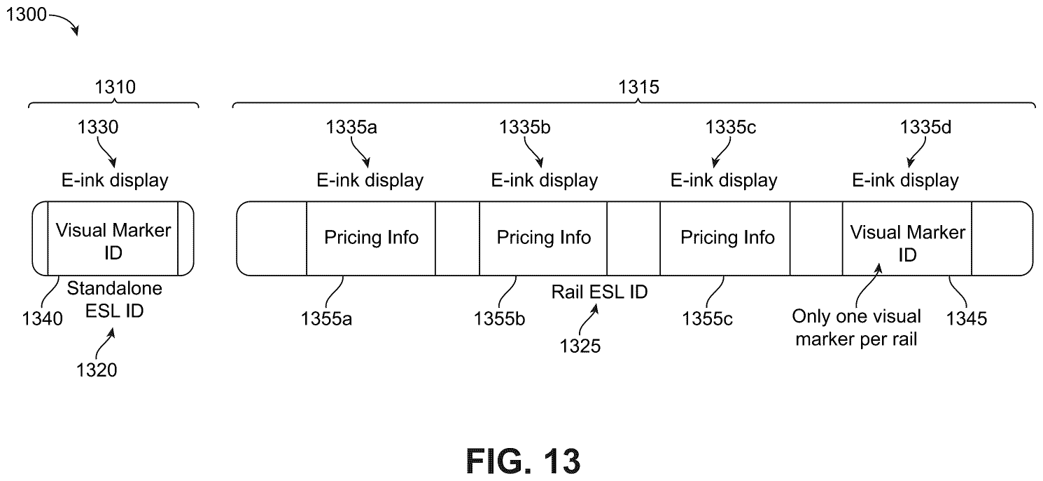

In some examples, the one or more processors may determine, based on mapping (e.g., at block 960) the first map (e.g., the planogram 910) to a second map (e.g., store layout 920) including the known locations (e.g., at position P2 1250a and position P1 1250b of FIG. 12) on the path (e.g., path 1060 of FIGS. 10 and 12), a respective location of each device (e.g., a tag, such as an ESL or e-tag) of the plurality of devices. For example, the one or more processors can determine a tag location X, Y, Z for positioning devices 980 based on mapping the first map (e.g., the planogram 910) to the second map (e.g., store layout 920). In one or more examples, determining the respective location of each device of the plurality of devices may be further based on performing triangulation using lines of sight from the known locations (e.g., at position P2 1250a and position P1 1250b of FIG. 12) on the path (e.g., path 1060 of FIGS. 10 and 12) to the visual markers in the images. In some examples, the respective location of each device may include coordinates X, Y, Z (e.g., cartesian coordinates) in a real-world space. In one or more examples, the second map can be a building layout. In some cases, the building layout can be a store layout or a warehouse layout. In one or more examples, each visual marker of the visual markers may be a fiducial marker (e.g., as shown by identifying marker 720 of FIG. 7). In some examples, two or more devices of the plurality of devices may be mounted on a wireless communication device rail (e.g., device rail 1325 of FIG. 13). In one or more examples, the plurality of objects (e.g., objects 830 of FIG. 8) includes a plurality of products. In some examples, each device (e.g., devices 360 of FIG. 3, devices 1040 of FIG. 10 and/or devices 1040a, 1040b of FIG. 12) may be a tag (e.g., an ESL, an e-tag, etc.).

FIG. 10 shows an example process for the detecting of visual markers (e.g., at block 940 of FIG. 9) by the process 900 of FIG. 9. In particular, FIG. 10 is a diagram illustrating an example of a process 1000 for detecting visual markers of devices (e.g., tags such as ESLs, e-tags, etc.). In FIG. 10, during operation of the process 1000, a camera 1050 (e.g., camera sensor) is shown to be traveling (e.g., moving) along a path 1060. The path 1060 is a known path 1060 that includes a plurality of ground truth locations along the length of the path 1060. The path 1060 may be within an aisle (e.g., aisle 350 of FIG. 3) that runs parallel to a shelving unit 1010 within a building (e.g., a retail store or warehouse). The shelving unit 1010 is shown to include a plurality of (e.g., five) shelves 1030. Each shelf 1030 is shown to include a plurality of devices 1040 (e.g., tags, such as ESLs, c-tags, etc.) along the length of the shelf 1030. There are also objects (not shown), such as products, housed on the shelves 1030 that are associated with the devices 1040.

While the camera 1050 is moving along the path 1060, the camera 1050 can obtain (e.g., capture), within the camera's field of view 1070, a plurality of images (e.g., image I) including the devices 1040. Each image of the plurality of images may be obtained from a respective position of the camera sensor 1050 at a known location on the path 1060. In some examples, each device 1040 of the plurality of devices 1040 can include a respective visual marker (e.g., identifying marker 720 of FIG. 7).

One or more processors (e.g., processor 210 of FIG. 1 and/or processor 1510 of FIG. 15) can detect, based on detecting the visual markers in the plurality of images (e.g., image I), an arrangement of the visual markers. The arrangement is how the devices are specifically organized on the shelves 1030 of the shelving unit 1010. Table 1020 shows the arrangement of the visual markers in a tabular format.

The arrangement (e.g., as shown in table 1020 of FIG. 10) of the visual markers may include a respective height (e.g., height one) of each of the visual markers, and an order of the visual markers for each of the respective heights. In some examples, the respective height for each of the visual markers may correspond to a respective shelf (e.g., shelves 1030 of FIG. 10) of a shelving unit (e.g., shelving unit 1010 of FIG. 10) associated with the first map (e.g., a planogram). In one or more examples, the first map may be a planogram (e.g., as shown in table 1110) for the plurality of objects.

For example, in table 1020, for visual markers detected at a height of one (1), which can indicate that these visual markers are located on the first shelf 1030 (e.g., bottom shelf 1030) of the shelving unit 1010, the order of the visual marker as they were detected by the camera 1050 moving along the path 1060 is shown. For example, on the bottom shelf 1030, the visual markers (e.g., as indicated by visual marker IDs) were detected in an order from the beginning of the path to the end of the path in the order of: 1D01, 1D02, 1D03, . . . , etc.

FIG. 11 shows an example process for aligning visual markers to a planogram (e.g., at block 950 of FIG. 9) by the process 900 of FIG. 9. In particular, FIG. 11 is a diagram illustrating an example of a process 1100 for aligning visual markers of a plurality of devices (e.g., tags, such as ESLs, e-tags, etc.) to a planogram. In FIG. 11, during operation of the process 1100, one or more processors (e.g., processor 210 of FIG. 1 and/or processor 1510 of FIG. 15) may pair, based on aligning the arrangement (e.g., table 1020 of FIGS. 10 and 11) of the visual markers with a first map (e.g., planogram, as shown in a tabular format in table 1110) comprising a corresponding arrangement of a plurality of objects (e.g., objects on the shelves 1030 of the shelving unit 1010 of FIG. 10), a respective object of the plurality of objects to each device of the plurality of devices.

Table 1130 shows an example of the pairing of the objects (e.g., each indicated by a product ID associated with the object) with the devices (e.g., each as indicated by a visual marker ID associated with the device). For example, in table 1130, an object with a product ID of P71 is paired with a device (e.g., a tag, such as an ESL, e-tag, etc.) with a visual marker ID of ID01.

FIG. 12 shown an example process for mapping the planogram to a store layout (e.g., at block 960 of FIG. 9) by the process 900 of FIG. 9. In particular, FIG. 12 is a diagram illustrating an example of a process 1200 for mapping a planogram to a store layout. In FIG. 12, a shelving unit 1010 including a plurality of shelves 1030a, 1030b is shown. Each shelf (e.g., shelves 1030a, 1030b) of the shelving unit 1010 includes a plurality of devices (e.g., devices 1040a, 1040b, such as tags). There are also objects (not shown), such as products, housed on the shelves (e.g., including shelves 1030a, 1030b) that are associated with the, devices (e.g., the tags, such as ESLs, e-tags, etc.).

In FIG. 12, during operation of the process 1200, one or more processors (e.g., processor 210 of FIG. 1 and/or processor 1510 of FIG. 15) may determine, based on mapping the first map (e.g., a planogram, as shown in table 1110) to a second map (e.g., a store layout) including the known locations (e.g., at position P2 1250a and position P1 1250b) on the path 1060, a respective location (e.g., in X, Y, Z coordinates) of each device (e.g., each tag). Determining the respective location (e.g., in X, Y, Z coordinates) of each of the devices may be further based on performing triangulation using lines of sight from the known locations (e.g., at position P2 1250a and position P1 1250b of FIG. 12) on the path 1060 to the visual markers in the images (e.g., to determine triangulated tag locations 1270). The respective location of each of the devices may include coordinates X, Y, Z (e.g., cartesian coordinates) in a real-world space. The second map may be a building layout. In some examples, the building layout may be a store layout or a warehouse layout.

FIG. 13 shows two different example device (e.g., tag) configurations for a fast tag survey using visual markers. In particular, FIG. 13 is a diagram 1300 illustrating examples 1310, 1315 of a standalone device 1320 (e.g., with a standalone tag ID, such as an ESL ID, e-tag ID, etc.) and a device rail 1325 (e.g., with a rail tag ID, such as a rail ESL ID, a rail e-tag ID, etc.) including a plurality of devices (e.g., tags, such as ESLs, e-tags, etc.). In FIG. 13, example 1310 shows the standalone device 1320 (e.g., a tag, such as an ESL ID, e-tag ID, etc.) that includes a display 1330 (e.g., an e-ink display screen) displaying a virtual marker 1340 (e.g., including a virtual marker ID) corresponding to the device.

In FIG. 13, example 1315 shows a plurality of (e.g., four) devices (e.g., tags, such as ESLs, e-tags, etc.) mounted on (and/or implemented within) a device rail 1325 (e.g., with a rail device ID, such as a rail tag ID). The first three of the four devices include a display 1335a, 1335b, 1335c (e.g., an e-ink display screen) displaying pricing info 1355a, 1355b, 1355c corresponding to objects associated with the devices, respectively. The fourth device of the four devices includes a display 1335d (e.g., an e-ink display screen) displaying a virtual marker 1345 (e.g., including a virtual marker ID) corresponding to the fourth device. In one or more examples, for each device rail (e.g., device rail 1325), only one device display (e.g., display 1335d) needs to display a virtual marker (e.g., virtual marker 1345). In one or more examples, each visual marker 1340, 1345 may be a fiducial marker (e.g., as shown by identifying marker 720 of FIG. 7).

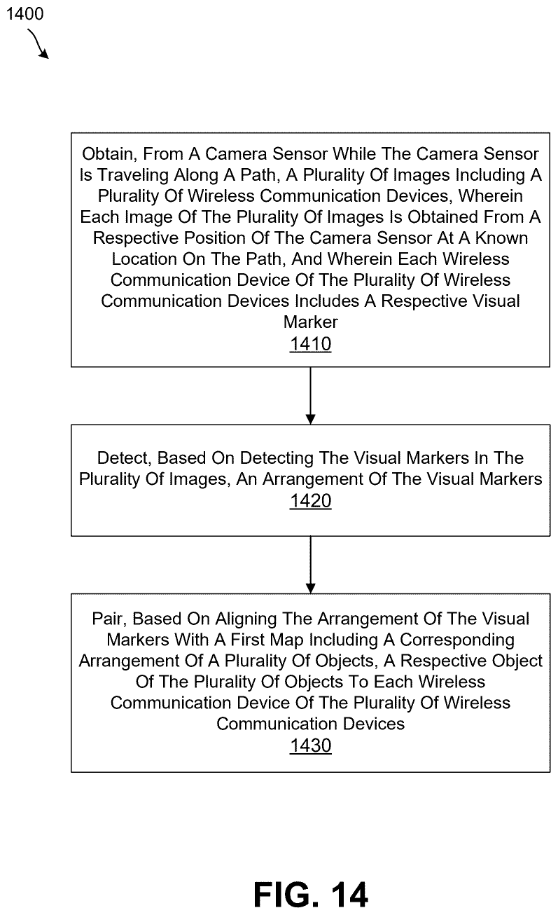

FIG. 14 is a flow chart illustrating an example of a process 1400 for surveying devices (e.g., tags or peripheral devices, such as ESLs, e-tags, etc.). The process 1400 can be performed by a computing device (e.g., a computing device implementing the system 610 of FIG. 6, a computing device implementing the computing system 1500 of FIG. 15, or other computing device) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1400 may be implemented as software components that are executed and run on one or more processors (e.g., processor 1510 of FIG. 15, or other processor(s)). Further, the transmission and reception of signals by the computing device in the process 1400 may be enabled, for example, by one or more antennas and/or one or more transceivers (e.g., wireless transceiver(s)).

At block 1410, the computing device (or component thereof) can obtain, from at least one camera sensor while the at least one camera sensor is traveling along a path, a plurality of images including a plurality of devices. Each image of the plurality of images is obtained from a respective position of the at least one camera sensor along the path. Each device of the plurality of devices includes a respective visual marker (e.g., a first device having a first visual marker, a second device having a second visual marker, and so on). In some cases, each of the visual markers is a fiducial marker (e.g., as shown in FIG. 7). In some aspects, each device of the plurality of devices is a tag (e.g., an electronic tag (e-tag), an electronic shelf label (ESL), or other type of tag). In some aspects, two or more devices of the plurality of devices are mounted on a device rail (e.g., device rail 1325).

At block 1420, the computing device (or component thereof) can detect visual markers of the plurality of devices in the plurality of images. For instance, the computing device (or component thereof) can detect a first visual marker (e.g., a first fiducial marker) of a first device (e.g., a first tag) in at least one of the images, a second visual marker (e.g., a second fiducial marker) of a second device (e.g., a second tag) in at least one of the images, and so on.

At block 1430, the computing device (or component thereof) can determine an arrangement (e.g., as shown in table 1020 of FIG. 10) of the visual markers detected in the plurality of images. In some aspects, the arrangement of the visual markers includes a respective height of each of the visual markers and an order of the visual markers for each of the respective heights. For instance, the respective height for each of the visual markers can correspond to a respective shelf of a shelving unit (e.g., a respective shelf from the shelves 1030 in the shelving unit 1010 of FIG. 10) associated with a first map including a corresponding arrangement of a plurality of objects (e.g., objects on which the devices, such as tags, are attached). In some aspects, the first map is a planogram (e.g., as shown in table 1110) for the plurality of objects.

At block 1440, the computing device (or component thereof) can pair, based on aligning the arrangement of the visual markers with the first map (e.g., the planogram) including the corresponding arrangement of the plurality of objects (e.g., objects 830 of FIG. 8), a respective object of the plurality of objects to each device of the plurality of devices. In some cases, the computing device (or component thereof) can align the arrangement of the visual markers with the first map.

In some aspects, the computing device (or component thereof) can determine, based on mapping the first map to a second map (e.g., a building layout in which the objects and devices, such as tags, are located, such as a store layout or a warehouse layout) including known locations on the path, a respective location of each device of the plurality of devices. In some cases, the computing device (or component thereof) can map the first map to the second map. In some aspects, the computing device (or component thereof) can determine the respective location of each device of the plurality of devices further based on performing triangulation using lines of sight from the known locations on the path to the visual markers in the plurality of images. In some cases, the respective location of each device of the plurality of devices includes coordinates in a real-world space.

In some cases, the computing device of process 1400 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1400 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a block diagram illustrating an example of a computing system 1500, which may be employed for a fast tag survey using visual markers. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., LiDAR sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for surveying devices, the apparatus comprising: at least one memory; and at least one processor coupled to the at least one memory and configured to: obtain, from at least one camera sensor while the at least one camera sensor is traveling along a path, a plurality of images comprising a plurality of devices, wherein each image of the plurality of images is obtained from a respective position of the at least one camera sensor along the path, and wherein each device of the plurality of devices comprises a respective visual marker; detect visual markers of the plurality of devices in the plurality of images; determine an arrangement of the visual markers detected in the plurality of images; and pair, based on aligning the arrangement of the visual markers with a first map comprising a corresponding arrangement of a plurality of objects, a respective object of the plurality of objects to each device of the plurality of devices.

Aspect 2. The apparatus of Aspect 1, wherein the arrangement of the visual markers comprises a respective height of each of the visual markers, and an order of the visual markers for each of the respective heights.

Aspect 3. The apparatus of Aspect 2, wherein the respective height for each of the visual markers corresponds to a respective shelf of a shelving unit associated with the first map.

Aspect 4. The apparatus of any of Aspects 1 to 3, wherein the first map is a planogram for the plurality of objects.

Aspect 5. The apparatus of any of Aspects 1 to 4, wherein the at least one processor is configured to determine, based on mapping the first map to a second map comprising known locations on the path, a respective location of each device of the plurality of devices.

Aspect 6. The apparatus of Aspect 5, wherein the at least one processor is configured to determine the respective location of each device of the plurality of devices is further based on performing triangulation using lines of sight from the known locations on the path to the visual markers in the plurality of images.

Aspect 7. The apparatus of any of Aspects 5 or 6, wherein the respective location of each device of the plurality of devices comprises coordinates in a real-world space.

Aspect 8. The apparatus of any of Aspects 5 to 7, wherein the second map is a building layout.

Aspect 9. The apparatus of Aspect 8, wherein the building layout is a store layout or a warehouse layout.

Aspect 10. The apparatus of any of Aspects 1 to 9, wherein each visual marker of the visual markers is a fiducial marker.

Aspect 11. The apparatus of any of Aspects 1 to 10, wherein two or more devices of the plurality of devices are mounted on a device rail.

Aspect 12. The apparatus of any of Aspects 1 to 11, wherein the plurality of objects comprises a plurality of products.

Aspect 13. The apparatus of any of Aspects 1 to 12, wherein each device of the plurality of devices is an electronic tag or an electronic shelf label.

Aspect 14. A method for surveying devices, the method comprising: obtaining, from at least one camera sensor while the at least one camera sensor is traveling along a path, a plurality of images comprising a plurality of devices, wherein each image of the plurality of images is obtained from a respective position of the at least one camera sensor along the path, and wherein each device of the plurality of devices comprises a respective visual marker; detecting visual markers of the plurality of devices in the plurality of images; determining an arrangement of the visual markers detected in the plurality of images; and pairing, based on aligning the arrangement of the visual markers with a first map comprising a corresponding arrangement of a plurality of objects, a respective object of the plurality of objects to each device of the plurality of devices.

Aspect 15. The method of Aspect 14, wherein the arrangement of the visual markers comprises a respective height of each of the visual markers, and an order of the visual markers for each of the respective heights.

Aspect 16. The method of Aspect 15, wherein the respective height for each of the visual markers corresponds to a respective shelf of a shelving unit associated with the first map.

Aspect 17. The method of any of Aspects 14 to 16, wherein the first map is a planogram for the plurality of objects.

Aspect 18. The method of any of Aspects 14 to 17, further comprising determining, based on mapping the first map to a second map comprising known locations on the path, a respective location of each device of the plurality of devices.

Aspect 19. The method of Aspect 18, wherein determining the respective location of each device of the plurality of devices is further based on performing triangulation using lines of sight from the known locations on the path to the visual markers in the plurality of images.

Aspect 20. The method of any of Aspects 18 or 19, wherein the respective location of each device of the plurality of devices comprises coordinates in a real-world space.

Aspect 21. The method of any of Aspects 18 to 20, wherein the second map is a building layout.

Aspect 22. The method of Aspect 21, wherein the building layout is a store layout or a warehouse layout.

Aspect 23. The method of any of Aspects 14 to 22, wherein each visual marker of the visual markers is a fiducial marker.

Aspect 24. The method of any of Aspects 14 to 23, wherein two or more devices of the plurality of devices are mounted on a device rail.

Aspect 25. The method of any of Aspects 14 to 24, wherein the plurality of objects comprises a plurality of products.

Aspect 26. The method of any of Aspects 14 to 25, wherein each device of the plurality of devices is an electronic tag or an electronic shelf label.

Aspect 27. A non-transitory computer-readable medium having stored thereon instructions that, when executed by at least one processor, cause the at least one processor to perform operations according to any of Aspects 14 to 26.

Aspect 28. An apparatus for surveying devices, the apparatus including one or more means for performing operations according to any of Aspects 14 to 26.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for surveying devices, the apparatus comprising:
at least one memory; and
at least one processor coupled to the at least one memory and configured to:
obtain, from at least one camera sensor while the at least one camera sensor is traveling along a path, a plurality of images comprising a plurality of devices, wherein each image of the plurality of images is obtained from a respective position of the at least one camera sensor along the path, and wherein each device of the plurality of devices comprises a respective visual marker;
detect visual markers of the plurality of devices in the plurality of images;
determine an arrangement of the visual markers detected in the plurality of images; and
pair, based on aligning the arrangement of the visual markers with a first map comprising a corresponding arrangement of a plurality of objects, a respective object of the plurality of objects to each device of the plurality of devices.

2. The apparatus of claim 1, wherein the arrangement of the visual markers comprises a respective height of each of the visual markers, and an order of the visual markers for each of the respective heights.

3. The apparatus of claim 2, wherein the respective height for each of the visual markers corresponds to a respective shelf of a shelving unit associated with the first map.

4. The apparatus of claim 1, wherein the first map is a planogram for the plurality of objects.

5. The apparatus of claim 1, wherein the at least one processor is configured to determine, based on mapping the first map to a second map comprising known locations on the path, a respective location of each device of the plurality of devices.

6. The apparatus of claim 5, wherein the at least one processor is configured to determine the respective location of each device of the plurality of devices is further based on performing triangulation using lines of sight from the known locations on the path to the visual markers in the plurality of images.

7. The apparatus of claim 5, wherein the respective location of each device of the plurality of devices comprises coordinates in a real-world space.

8. The apparatus of claim 5, wherein the second map is a building layout.

9. The apparatus of claim 1, wherein each visual marker of the visual markers is a fiducial marker.

10. The apparatus of claim 1, wherein two or more devices of the plurality of devices are mounted on a device rail.

11. The apparatus of claim 1, wherein each device of the plurality of devices is an electronic tag or an electronic shelf label.

12. A method for surveying devices, the method comprising:
obtaining, from at least one camera sensor while the at least one camera sensor is traveling along a path, a plurality of images comprising a plurality of devices, wherein each image of the plurality of images is obtained from a respective position of the at least one camera sensor along the path, and wherein each device of the plurality of devices comprises a respective visual marker;
detecting visual markers of the plurality of devices in the plurality of images;
determining an arrangement of the visual markers detected in the plurality of images; and
pairing, based on aligning the arrangement of the visual markers with a first map comprising a corresponding arrangement of a plurality of objects, a respective object of the plurality of objects to each device of the plurality of devices.

13. The method of claim 12, wherein the arrangement of the visual markers comprises a respective height of each of the visual markers, and an order of the visual markers for each of the respective heights.

14. The method of claim 13, wherein the respective height for each of the visual markers corresponds to a respective shelf of a shelving unit associated with the first map.

15. The method of claim 12, wherein the first map is a planogram for the plurality of objects.

16. The method of claim 12, further comprising determining, based on mapping the first map to a second map comprising known locations on the path, a respective location of each device of the plurality of devices.

17. The method of claim 16, wherein determining the respective location of each device of the plurality of devices is further based on performing triangulation using lines of sight from the known locations on the path to the visual markers in the plurality of images.

18. The method of claim 16, wherein the respective location of each device of the plurality of devices comprises coordinates in a real-world space.

19. The method of claim 12, wherein each visual marker of the visual markers is a fiducial marker.

20. The method of claim 12, wherein two or more devices of the plurality of devices are mounted on a device rail.
